(19) United States
(12) Patent Application Publication
(10) Pub. No.: US 2022/0198401 A1
(43) Pub. Date: Jun. 23, 2022

(54) ATTENDANCE MANAGEMENT SYSTEM

(71) Applicant: JVCKENWOOD Corporation, Yokohama-shi (JP)

(72) Inventors: Masashi Uemoto, Yokohama-shi (JP); Hiromitsu Asaka, Yokohama-shi (JP); Toru Kaiwa, Yokohama-shi (JP); Masaki Takei, Yokohama-shi (JP); Misa Nishibe, Yokohama-shi (JP); Miharu Kobayashi, Yokohama-shi (JP); Kaoru Shimizu, Yokohama-shi (JP)

(21) Appl. No.: 17/546,086

(22) Filed: Dec. 9, 2021

(30) Foreign Application Priority Data
Dec. 22, 2020 (JP) 2020-212766
Dec. 22, 2020 (JP) 2020-213024

(51) Int. Cl. G06Q 10/10; G06Q 10/06; H04R 1/10; H04W 4/38

(52) U.S. Cl. CPC G06Q 10/1091; H04W 4/38; H04R 1/10; G06Q 10/063114

(57) ABSTRACT

An attendance management system includes a management device configured to manage attendance of a user and one earphone capable of performing a wireless communication with the management device, wherein the earphone is capable of detecting whether the earphone is mounted on the user and transmitting a result of the detection to the management device, and the management device determines that the user is at work when it is detected that a use state of the earphone is a predetermined state in which the earphone is communicably connected to the management device and mounted on the user.

### CROSS-REFERENCE TO RELATED APPLICATIONS

This application claims priority from Japanese Applications No. 2020-212766 and No. 2020-213024, both filed on Dec. 22, 2020, the contents of both of which are incorporated by reference herein in its entirety.

### FIELD

The present application relates to an attendance management system.

### BACKGROUND

When an attendance status management is performed in what is called a telework environment in which a person works at home or other sites, a technology is employed with which the person is caused to transmit an attendance status such as a start of working or an end of working by electronic mail or the like or to read a dedicated two-dimensional code or the like (refer to Japanese Patent Application Laid-open No. 2007-293834, for example).

However, with the above-described method, the attendance status management is more burdensome as compared to a case of working at an office. Thus, it is required to be able to easily perform the attendance status management.

### SUMMARY

An attendance management system is disclosed.

According to one aspect, there is provided an attendance management system comprising: a management device configured to manage attendance of a user; and one earphone capable of performing a wireless communication with the management device, wherein the earphone is capable of detecting whether the earphone is mounted on the user and transmitting a result of the detection to the management device, and the management device is further configured to determine that the user is at work when it is detected that a use state of the earphone is a predetermined state in which the earphone is communicably connected to the management device and mounted on the user.

According to one aspect, there is provided an attendance management system comprising: a management device configured to manage attendance of a user; and multiple earphones capable of performing a wireless communication with the management device respectively, wherein each of the earphones is capable of detecting whether the earphone is mounted on the user and transmitting a result of the detection to the management device, and the management device is further configured to determine that the user is at work when it is detected that a use state of a first earphone as one of the multiple earphones is a predetermined state in which the earphone is communicably connected to the management device and mounted on the user.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram schematically illustrating an exemplary attendance management system according to a first embodiment;

FIG. 2 is a functional block diagram illustrating the exemplary attendance management system according to the first embodiment;

FIG. 3 is a diagram illustrating an exemplary use aspect of the attendance management system according to the first embodiment;

FIG. 4 is a diagram illustrating an exemplary use aspect of the attendance management system according to the first embodiment;

FIG. 5 is a diagram illustrating an exemplary use aspect of the attendance management system according to the first embodiment;

FIG. 6 is a flowchart illustrating an exemplary flow of processes of the attendance management system according to the first embodiment;

FIG. 7 is a flowchart illustrating an exemplary flow of processes of the attendance management system according to the first embodiment;

FIG. 8 is a diagram schematically illustrating an exemplary attendance management system according to a second embodiment;

FIG. 9 is a functional block diagram illustrating the exemplary attendance management system according to the second embodiment;

FIG. 10 is a diagram illustrating an exemplary use aspect of the attendance management system according to the second embodiment; and

FIG. 11 is a flowchart illustrating an exemplary flow of processes of the attendance management system according to the second embodiment.

### DETAILED DESCRIPTION OF THE PREFERRED EMBODIMENTS

Embodiments of an attendance management system according to the present disclosure will be described below with reference to the accompanying drawings. The present application is not limited by the embodiments. Components in the embodiments described below include those that can be easily replaced by the skilled person in the art or those identical in effect.

### First Embodiment

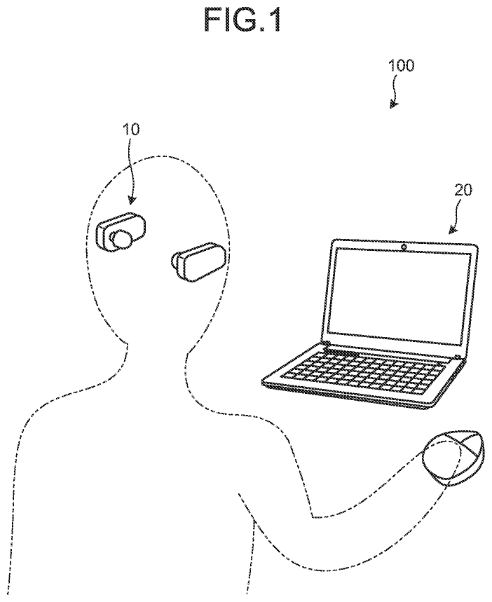

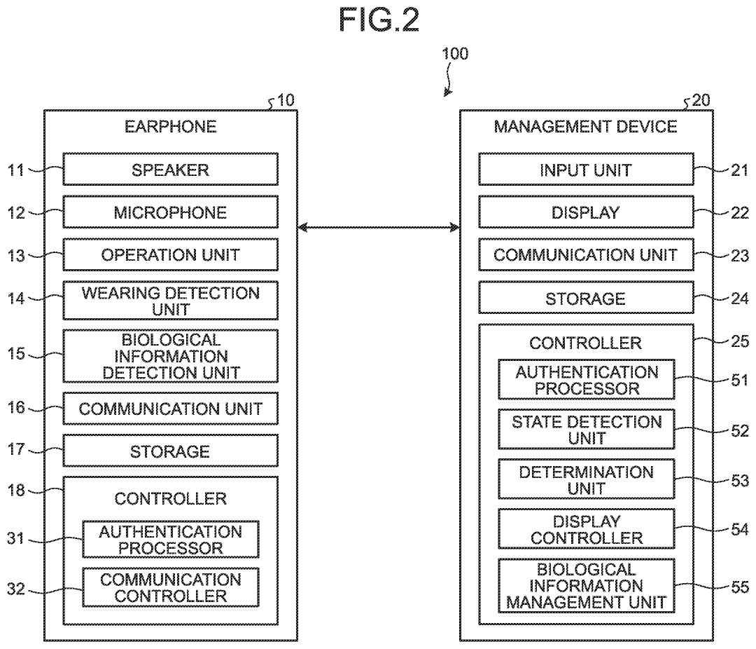

FIG. 1 is a diagram schematically illustrating an exemplary attendance management system 100 according to a first embodiment. FIG. 2 is a functional block diagram illustrating the exemplary attendance management system 100 according to the first embodiment. As illustrated in FIGS. 1 and 2, the attendance management system 100 includes an earphone 10 and a management device 20.

The earphone 10 is, for example, separate wireless earphones including a right earphone and a left earphone. The right and left earphones can wirelessly communicate with each other. The earphone 10 may be used in an aspect in which the right and left earphones are both mounted or may be used in an aspect in which only one of them is mounted. In the present embodiment, the earphone 10 may include both of the right and left earphones or may include one of the right and left earphones. In the present embodiment, description of some configurations and operations such as individual configurations of the right and left earphones and specific communication operation between the right and left earphones is omitted. At least one of the right and left earphones necessarily need to have the configuration of the earphone 10 described below.

The earphone 10 includes a speaker 11, a microphone 12, an operation unit 13, a wearing detection unit 14, a biological information detection unit 15, a communication unit 16, a storage 17, and a controller 18. The earphone 10 includes a power source unit that is not illustrated but is configured to supply electric power to each of the above-described components.

The speaker 11 outputs a sound information received from the management device 20. The speaker 11 is provided to each of the right and left earphones.

The microphone 12 receives sound from a surrounding environment and generates a sound information. The microphone 12 is provided to at least one of the right and left earphones.

The operation unit 13 is a unit through which a user can input an operation signal to the earphone 10. The operation unit 13 includes, for example, a touch sensor configured to detect a touch by the user. Predetermined operations such as power on/off and start/stop of music reproduction can be input through the operation unit 13.

The wearing detection unit 14 detects a wearing state of the earphone 10 by the user. The wearing detection unit 14 can automatically detect a mounted state in which the earphone 10 is mounted on the user and a non-mounted state (or removed state) in which the earphone 10 is not mounted on the user. The wearing detection unit 14 transmits a result of the detection to the controller 18. The wearing detection unit 14 performs the above-described detection and detection-result transmission, for example, at every predetermined time.

The biological information detection unit 15 acquires a biological information of the user when the earphone 10 is in the mounted state. Examples of the biological information include a heart rate, a breathing rate, a blood pressure, a body temperature, a brain wave, a perspiration amount, a user's body motion, and an oxygen saturation of arterial blood. The biological information detection unit 15 may be, for example, any of a heart rate meter, a blood pressure meter, a thermometer, and a pulse oximeter or may be a combination thereof.

The communication unit 16 receives a sound information transmitted from the management device 20. The communication unit 16 transmits a sound information generated by the microphone 12 to the management device 20. The communication unit 16 transmits and receives, to and from the management device 20, an authentication information that is necessary for authentication. The communication unit 16 transmits, to the management device 20, various kinds of information such as the biological information of the user detected by the biological information detection unit 15 and the use state of the earphone 10 described later.

The storage 17 stores various kinds of information. The storage 17 includes a random access memory (RAM), a read only memory (ROM), and the like. The storage 17 may be an external storage medium such as a removable media. The storage 17 stores, for example, the above-described authentication information.

The controller 18 includes a processing device such as a central processing unit (CPU). The controller 18 includes an authentication processor 31 and a communication controller 32.

The authentication processor 31 performs an authentication processing such as a pairing between the earphone 10 and the management device 20. The authentication processor 31 stores, in the storage 17, information of the management device 20 for which the authentication is made.

The communication controller 32 causes the communication unit 16 to transmit and receive information. When a power-on operation is input through the operation unit 13, the communication controller 32 establishes a state in which communication is possible with the management device 20. The communication controller 32 causes the communication unit 16 to transmit, to the management device 20, a result of the detection by the wearing detection unit 14, in other words, information of whether the earphone 10 is in the mounted state or the non-mounted state (removed state). Each time the result of the detection by the wearing detection unit 14 is output, the communication controller 32 causes the transmission of the detection result to the management device 20. In addition, the communication controller 32 causes the communication unit 16 to transmit the biological information detected by the biological information detection unit 15 to the management device 20. Each time the biological information is detected, the communication controller 32 causes the transmission of the biological information to the management device 20.

The management device 20 manages the attendance of the user. Examples of the management device 20 include various kinds of information terminals such as a cellular phone, a smartphone, a tablet, a laptop personal computer, and a desktop personal computer. The management device 20 includes an input unit 21, a display 22, a communication unit 23, a storage 24, and a controller 25.

The input unit 21 can receive a predetermined input operation for inputting information. The input unit 21 outputs an instruction signal to the controller 25 in accordance with the input operation. The input unit 21 is an input device such as a keyboard or a touch panel. In addition to or in place of these input devices, a button, a lever, a dial, a switch, and other input devices may be used as the input unit 21. The input unit 21 outputs the instruction signal in accordance with the predetermined input operation.

The display 22 is a display panel such as a liquid crystal panel and displays various kinds of information including a character and an image.

The communication unit 23 communicates information with the communication unit 16 of the earphone 10 by, for example, short-distance wireless communication.

The storage 24 stores various kinds of information. The storage 24 includes a storage such as a hard disk drive or a solid state drive. The storage 24 may be an external storage medium such as a removable disk. The storage 24 stores an operating system of the management device 20 and various computer programs, data, and the like for controlling operation of the input unit 21, the display 22, and the communication unit 23. The storage 24 stores an attendance management program configured to manage the attendance of the user.

The controller 25 controls each of the input unit 21, the display 22, and the communication unit 23. The controller 25 includes a processing device such as a CPU, and a storage device such as a RAM or a ROM. As illustrated in FIG. 2, the controller 25 includes an authentication processor 51, a state detection unit 52, a determination unit 53, a display controller 54, and a biological information management unit 55.

The authentication processor 51 performs an authentication processing such as a pairing between the earphone 10 and the management device 20. The authentication processor 51 stores, in the storage 24, information of the earphone 10 for which the authentication is made.

The state detection unit 52 detects the use state of the earphone 10 based on the information transmitted from the earphone 10. The use state of the earphone 10 includes a predetermined state and a non-predetermined state. In the predetermined state, the earphone 10 is in a connected state in which the earphone 10 is communicably connected to the management device 20, and is in a mounted state in which the earphone 10 is mounted on the user. The non-predetermined state is different from the predetermined state. The non-predetermined state includes, for example, a non-mounted state in which the earphone 10 is not mounted or is removed, and a non-connected state in which the communication between the earphone 10 and the management device 20 is disconnected.

The state detection unit 52 detects the state (connected state or non-connected state) of the communication between the communication unit 16 and the management device 20. The state detection unit 52 also detects the wearing state (mounted state or non-mounted state) of the earphone 10 based on the result of the detection by the wearing detection unit 14, the result of the detection having been received by the communication unit 23. The state detection unit 52 detects that the earphone 10 is in the predetermined state, when having detected that the communication state is the connected state and the wearing state is the mounted state. The state detection unit 52 detects that the earphone 10 is in the non-predetermined state, when having detected that the communication state is the non-connected state or the wearing state is the non-mounted state. The state detection unit performs the above-described detection, for example, in every certain period.

The determination unit 53 determines that the user of the earphone 10 is at work, when it is detected by the state detection unit 52 that the earphone 10 is in the predetermined state. The state detection unit 52 performs the determination, for example, each time the use state of the earphone 10 is detected by the state detection unit 52.

The determination unit 53 performs the following processing when it is detected by the state detection unit 52 that the earphone 10 in the predetermined state has become the non-predetermined state.

First, when a time at which the non-predetermined state is detected by the state detection unit 52 is later than a work-finish scheduled time, in other words, when the non-predetermined state is detected after the work-finish scheduled time, the determination unit 53 determines the time at which the non-predetermined state is detected as a work-finish time and determines that the user has finished work.

When it is detected by the state detection unit 52 that the earphone 10 returns to the predetermined state from the non-predetermined state before a predetermined time elapses after the detection of the non-predetermined state of the earphone 10, the determination unit 53 determines that the user is at work for a non-predetermined period in which the earphone 10 is in the non-predetermined state. In the determination, it is determined that the user is at work when a short-time work interruption or the like is detected, for example, when the user temporarily leaves a desk. Examples of a case in which the user leaves the desk include a case in which the user leaves the desk after removing the earphone 10 and a case in which the user leaves the desk while the earphone 10 is mounted on the user. When removed, the earphone 10 becomes the non-mounted state. When the user leaves the desk while the earphone 10 is mounted on the user, the short-distance wireless connection between the earphone 10 and the management device 20 is disconnected and the communication state becomes the non-connected state.

When it is detected by the state detection unit 52 that the earphone 10 returns to the predetermined state from the non-predetermined state after the predetermined time elapses after the detection of the non-predetermined state of the earphone 10, the determination unit 53 determines that the user has not been at work in the non-predetermined period, in other words, the user has been at non-work. In the determination, it is determined that the user is at non-work when a long-time work interruption or the like is detected, for example, when the user leaves the desk for a meal in a lunch time.

The display controller 54 controls a display operation of the display 22. The display controller 54 can cause the display 22 to display, for example, a guide screen for allowing the user to check a result of the detection by the state detection unit 52.

The biological information management unit 55 manages the biological information transmitted from the earphone 10. The biological information management unit 55 stores, in the storage 24, for example, the detection time at which the detection was performed by the biological information detection unit 15 and the biological information of the user as a result of the detection in association with each other. For example, the biological information management unit 55 can detect whether the biological information includes anomaly or the like. When having detected anomaly or the like, the biological information management unit 55 can cause a notification of the detection to be transmitted to, for example, an external device.

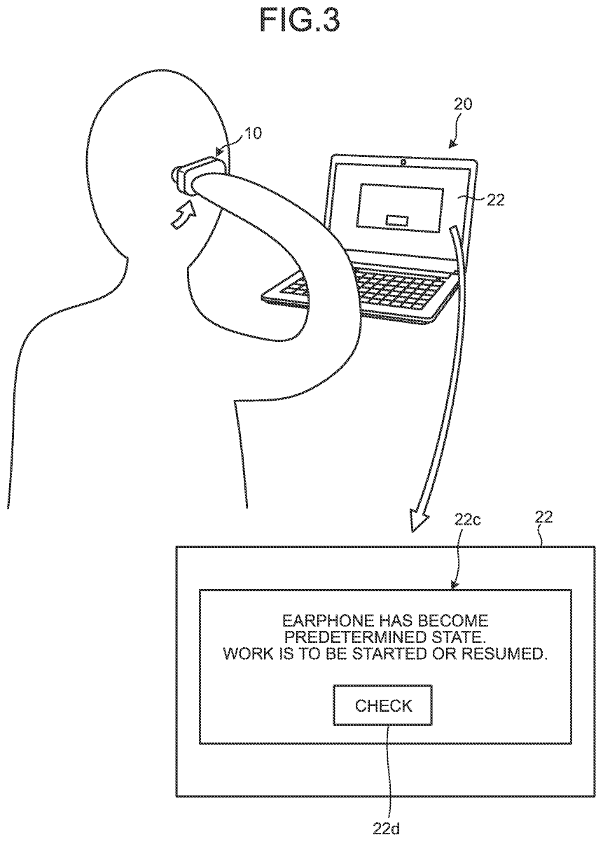

Subsequently, a use aspect of the attendance management system 100 configured as described above will be described. Authentication is achieved between the earphone 10 and the management device 20 beforehand. FIGS. 3 to 5 are diagrams illustrating an exemplary use aspect of the attendance management system 100.

When a power-on operation is input to the operation unit 13 by the user, the communication controller 32 achieves a connected state of the short-distance wireless communication with the management device 20. When the earphone 10 is mounted on the user, the wearing detection unit 14 detects that the earphone 10 has become the mounted state. When the earphone 10 has become the mounted state, the biological information detection unit 15 detects the biological information of the user. The communication controller 32 causes the communication unit 16 to transmit, to the management device 20, the result of the detection by the wearing detection unit 14 and the biological information detected by the biological information detection unit 15.

In the management device 20, the state detection unit 52 detects the connected state with the earphone 10. The communication unit 16 receives the result of the detection by the wearing detection unit 14 and the biological information. The state detection unit 52 detects that the earphone 10 is in the mounted state based on the result of the detection by the wearing detection unit 14. In this case, the state detection unit 52 detects that the earphone 10 is in the connected state and the mounted state, in other words, in the predetermined state. The determination unit 53 determines that the user is at work based on the result of the detection by the state detection unit 52.

As illustrated in FIG. 3, the display controller 54 can cause the display 22 to display a guide screen 22c for allowing the user to check the result of the detection by the state detection unit 52. The display controller 54 displays, on the guide screen 22c, for example, that the earphone 10 has become the predetermined state and that work is to be started or resumed. The user can confirm a display content by operating the input unit 21 to press a check button 22d. In a case in which the guide screen 22c is displayed, the determination unit 53 may determine that the user is at work based on an input of information that the display content is confirmed by the user as a trigger. No guide screen 22c may be displayed. The trigger for the determination by the determination unit 53 is not limited to the confirmation upon the display of the guide screen 22c and the operation of the check button 22d. For example, the trigger may be a user's input voice such as “work is to be started” through the microphone 12 of the earphone 10 and this input is transmitted to the management device 20 and detected by the management device 20.

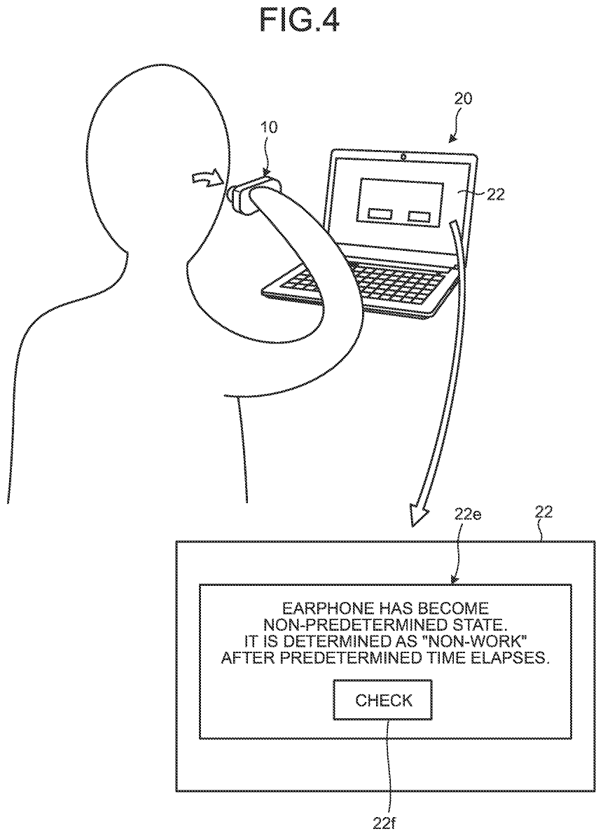

Thereafter, as illustrated in FIG. 4, for example, when the earphone 10 is removed by the user, the wearing detection unit 14 detects that the earphone 10 has become the removed state, in other words, the non-mounted state. The communication controller 32 causes the communication unit 16 to transmit the result of the detection by the wearing detection unit 14 to the management device 20.

In the management device 20, the communication unit 16 receives the result of the detection by the wearing detection unit 14. The state detection unit 52 detects that the earphone 10 has become the non-mounted state, in other words, the non-predetermined state based on the result of the detection by the wearing detection unit 14. The state detection unit 52 stores, in the storage 24, a time at which the earphone 10 becomes the non-predetermined state.

The determination unit 53 determines whether the time at which the earphone 10 becomes the non-predetermined state is later than the work-finish scheduled time of the user. When it is determined that the work-finish scheduled time is passed, the determination unit 53 regards the time stored in the storage 24 as the work-finish time and determines that the user has finished work.

After it is determined that the time at which the earphone 10 becomes the non-predetermined state is not later than the work-finish scheduled time of the user, the determination unit 53 determines that the user has been at work in the non-predetermined period of the earphone 10 when it is detected by the state detection unit 52 that the earphone 10 returns to the predetermined state from the non-predetermined state before the predetermined time elapses after the detection of the non-predetermined state of the earphone 10.

When it is detected by the state detection unit 52 that the earphone 10 returns to the predetermined state from the non-predetermined state after the predetermined time elapses after the detection of the non-predetermined state of the earphone 10, the determination unit 53 determines that the user has been at non-work in the non-predetermined period of the earphone 10.

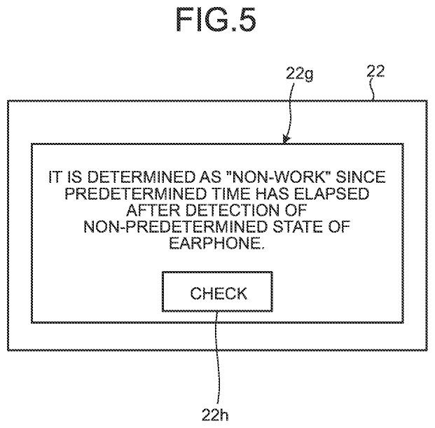

As illustrated in FIGS. 4 and 5, the display controller 54 can cause the display 22 to display the guide screen for causing the user to check the result of the detection by the state detection unit 52.

In the example illustrated in FIG. 4, the display controller 54 displays a guide screen 22e indicating that, for example, the earphone 10 has become the non-predetermined state and the user is determined to be at non-work when the earphone 10 returns to the predetermined state after the predetermined time elapses after the detection of the non-predetermined state of the earphone 10. The user can confirm the result of the detection by operating the input unit 21 to press a check button 22f.

In the example illustrated in FIG. 5, the display controller 54 displays a guide screen 22g indicating that the user is determined to be at non-work since the predetermined time has elapsed after the detection of the non-predetermined state of the earphone 10. The user can confirm the determination result by operating the input unit 21 to press a check button 22h.

In a case in which the guide screens 22e and 22g are displayed, the determination unit 53 may determine that the user is at work or non-work based on the input of information that the display content is confirmed by the user as a trigger. No guide screens 22e and 22g may be displayed. The trigger for the determination by the determination unit 53 is not limited to confirmation upon the display of the guide screens 22e and 22g and operations of the check buttons 22f and 22h. For example, the trigger may be a user's input voice such as “work is to be interrupted” through the microphone 12 of the earphone 10 and this input is transmitted to the management device 20 and detected by the management device 20.

The biological information management unit 55 stores the biological information received from the earphone 10 and the detection time of the biological information in association with each other in the storage 24. For example, the biological information management unit 55 detects whether the biological information includes anomaly or the like. When having detected the anomaly or the like, the biological information management unit 55 causes the communication unit 23 to transmit a notification of the detection to, for example, an external device.

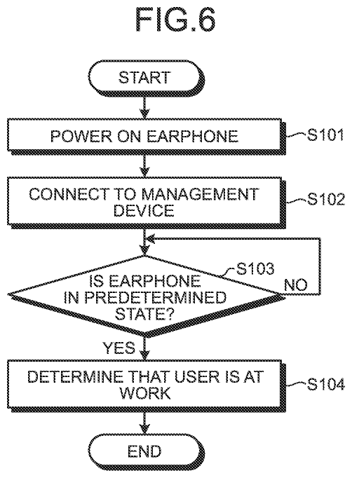

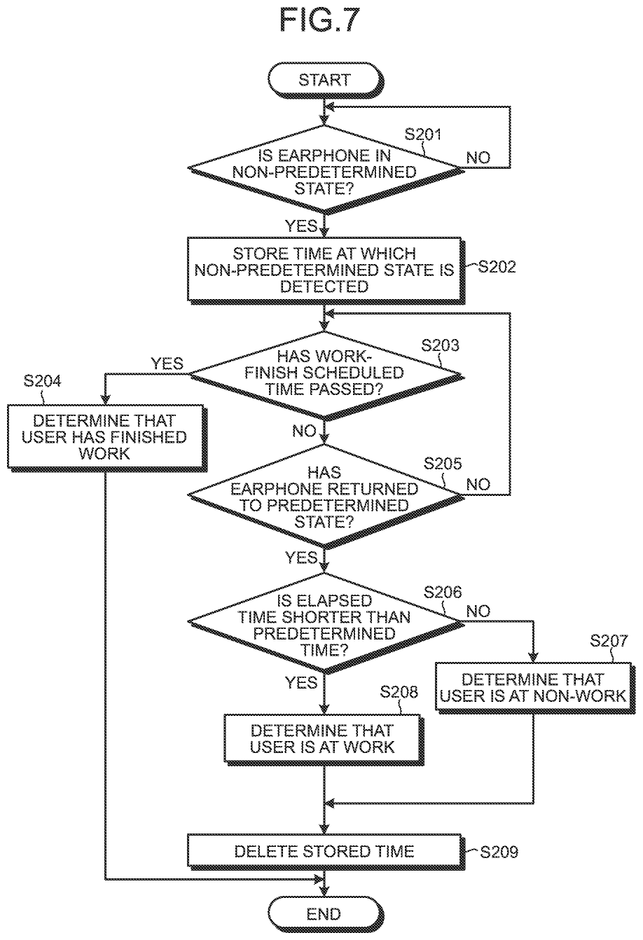

FIGS. 6 and 7 are flowcharts illustrating exemplary processes of operation of the attendance management system 100 according to the present embodiment. As illustrated in FIG. 6, when an operation to power on the earphone 10 is input to the operation unit 13 by the user (step S101), the communication controller 32 achieves a connected state with the management device 20 (step S102).

The state detection unit 52 detects whether the earphone 10 is in the predetermined state (step S103). When it is detected that the earphone 10 is in the predetermined state (Yes at step S103), the determination unit 53 determines that the user is at work (step S104). When it is detected that the earphone 10 is not in the mounted state (No at step S103), the processing at step S103 is repeated.

Thereafter, as illustrated in FIG. 7, the determination unit 53 determines whether it is detected that the earphone 10 has become the non-predetermined state (step S201). When it is not detected the earphone 10 has become the non-predetermined state (No at step S201), processing at step S201 is repeated. When it is detected that the earphone 10 has become the non-predetermined state (Yes at step S201), the determination unit 53 stores the time of the detection in the storage 24 (step S202).

The determination unit 53 determines whether the time at which the earphone 10 becomes the non-predetermined state is later than the work-finish scheduled time of the user (step S203). When it is determined that the work-finish scheduled time has passed (Yes at step S203), the determination unit 53 regards the time stored in the storage 24 as the work-finish time and determines that the user has finished work (step S204), and then ends the processes.

When it is determined that the work-finish scheduled time has not passed (No at step S203), the determination unit 53 determines whether it is detected that the earphone 10 has returned to the predetermined state (step S205). When it is not detected that the earphone 10 has returned to the predetermined state (No at step S205), the processes at step S203 and the later are repeated. When it is detected that the earphone 10 has returned to the predetermined state (Yes at step S205), the determination unit 53 determines whether a time from the time at which the earphone 10 became the non-predetermined state to the time at which the earphone 10 has become the predetermined state again is shorter than the predetermined time (step S206). When it is determined that the time is not shorter than the predetermined time (No at step S206), the determination unit 53 determines that the user has been at non-work in the non-predetermined period from the time at which the earphone 10 became the non-predetermined state to the time at which the earphone 10 has become the predetermined state again (step S207).

When it is determined that this non-mounted time is shorter than the predetermined time (Yes at step S206), the determination unit 53 determines that the user is at work (away from the desk) in the non-predetermined duration from the time at which the earphone 10 became the non-predetermined state to the time at which the earphone 10 has become the predetermined state again (step S208). After steps S207 and S208, the controller 25 deletes, from the storage 24, the time at which the earphone 10 became the non-predetermined state (step S209), and then completes the processes.

As described above, the attendance management system 100 according to the present embodiment includes the management device 20 configured to manage the attendance of the user, and one earphone 10 capable of performing the wireless communication with the management device 20. The earphone 10 can detect whether the earphone 10 is mounted on the user and transmit the result of the detection to the management device 20. The management device 20 determines that the user is at work, when having detected that the use state of the earphone 10 is the predetermined state in which the earphone 10 is communicably connected to the management device 20 and mounted on the user.

According to the present embodiment, the attendance status of the user can be determined based on the use state of the earphone 10, and thus the attendance status of the user can be easily managed.

In the attendance management system 100 according to the present embodiment, after it is detected that the earphone 10 in the predetermined state has become the non-predetermined state different from the predetermined state, the management device 20 determines that the user is at work, when it is detected that the earphone 10 has returned to the predetermined state from the non-predetermined state before the predetermined time elapses after the detection of the non-predetermined state of the earphone 10, and determines that the user has not been at work, when it is detected that the earphone 10 has returned to the predetermined state from the non-predetermined state after the predetermined time elapses after the detection of the non-predetermined state of the earphone 10. With this configuration, the non-predetermined state in a time shorter than the predetermined time is determined to be at work, and thus the attendance status of the user can be realistically managed.

In the attendance management system 100 according to the present embodiment, the management device 20 determines that the user has finished work, when having detected that the earphone 10 in the predetermined state has become the non-predetermined state after the work-finish scheduled time. With this configuration, it can be easily managed that the user has finished work.

In the attendance management system 100 according to the present embodiment, after having detected that the earphone 10 has become the predetermined state or the non-predetermined state, the management device 20 determines the attendance of the user, when having received the information allowing the user to confirm that the earphone 10 has become the predetermined state or the non-predetermined state. With this configuration, it is possible to allow the user to reliably recognize the result of the determination by the management device 20.

In the attendance management system 100 according to the present embodiment, the earphone 10 mounted on the user acquires the biological information of the user and transmits the acquired biological information to the management device 20, and the management device 20 manages health of the user based on the biological information of the user. With this configuration, the management device 20 can manage the attendance of the user as well as the health thereof.

### Second Embodiment

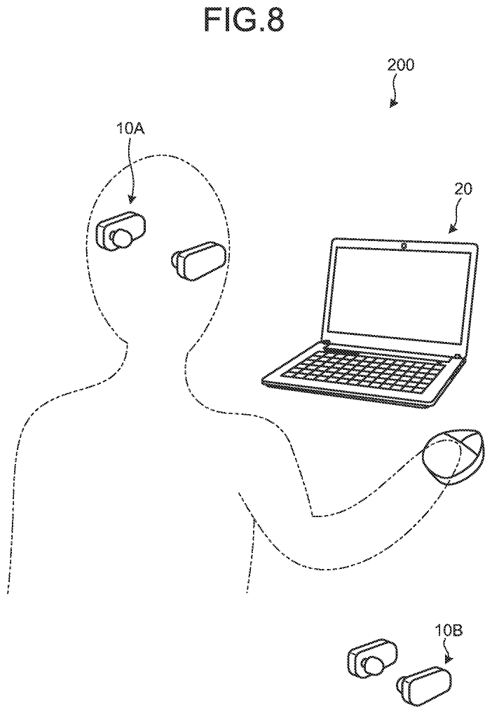

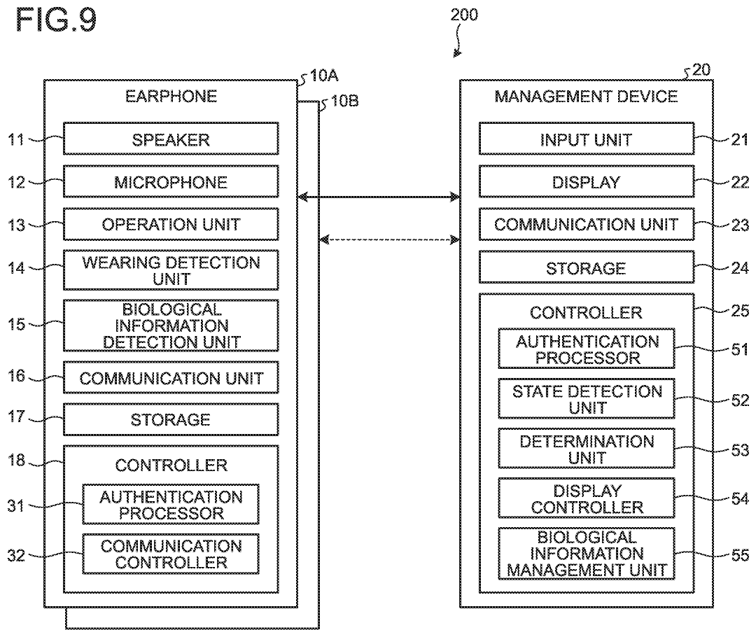

FIG. 8 is a diagram schematically illustrating an exemplary attendance management system 200 according to a second embodiment. FIG. 9 is a functional block diagram illustrating the exemplary attendance management system 200 according to the second embodiment. As illustrated in FIGS. 8 and 9, in the second embodiment, the attendance management system 200 includes the management device 20, and multiple earphones 10A and 10B capable of performing a wireless communication with the management device 20. One of the multiple earphones 10A and 10B can be used, for example, when a battery remaining amount of the other becomes zero.

Each of the earphones 10A and 10B has the configuration same as that of the earphone 10 described in the first embodiment. In the following description, each component of the earphones 10A and 10B is denoted by a reference sign same as that of the corresponding component of the earphone 10 described in the first embodiment. The present embodiment is described with an example in which the two earphones 10A and 10B are provided, but the present application is not limited thereto, and the same description applies to a case in which three or more earphones are provided. Hereinafter, the earphones 10A and 10B are referred to as the first earphone 10A and the second earphone 10B when distinguished from each other.

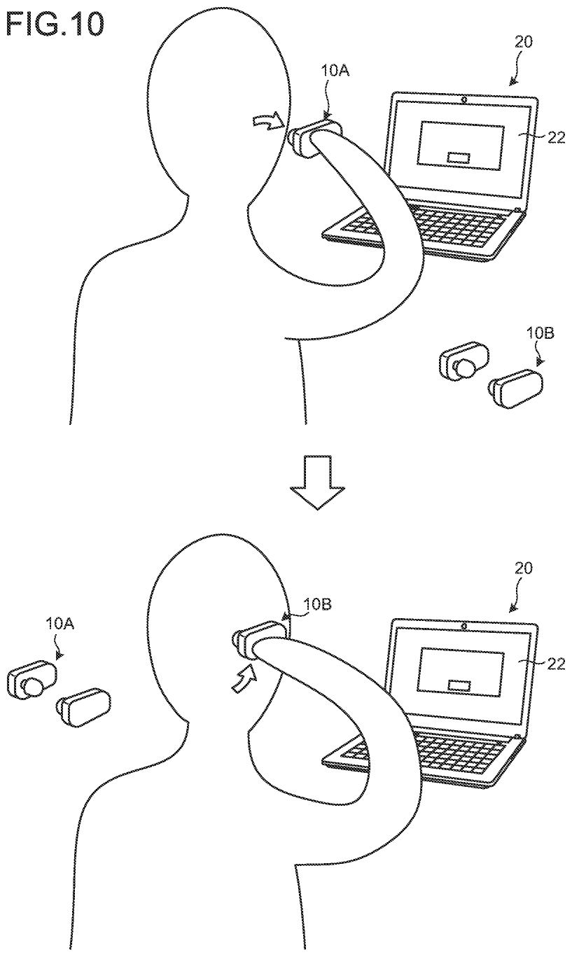

Subsequently, a use aspect of the attendance management system 200 will be described. FIG. 10 is a diagram illustrating an exemplary use aspect of the attendance management system 200. The first earphone 10A and the second earphone 10B are authenticated by the management device 20 in advance. When a power-on operation is input to, for example, the operation unit 13 of the first earphone 10A by a user, the communication controller 32 achieves a connected state of a short-distance wireless communication with the management device 20. When the first earphone 10A is mounted on the user, the wearing detection unit 14 detects that the first earphone 10A has become the mounted state. When the first earphone 10A has become the mounted state, the biological information detection unit 15 detects a biological information of the user. The communication controller 32 causes the communication unit 16 to transmit, to the management device 20, a result of the detection by the wearing detection unit 14 and the biological information detected by the biological information detection unit 15.

In the management device 20, the state detection unit 52 detects the connected state with the first earphone 10A. The communication unit 16 receives the result of the detection by the wearing detection unit 14 and the biological information. The state detection unit 52 detects that the first earphone 10A is in the mounted state based on the result of the detection by the wearing detection unit 14. In this case, the state detection unit 52 detects that the first earphone 10A is in the connected state and the mounted state, in other words, in the predetermined state. The determination unit 53 determines that the user is at work based on the result of the detection by the state detection unit 52. Similarly to the first embodiment, the result of the detection by the state detection unit 52 may be presented to the user for confirmation, and the determination unit 53 may perform the determination based on information indicating that the result is confirmed by the user as a trigger.

Thereafter, when the first earphone 10A is removed by the user as illustrated in an upper part of FIG. 10, the wearing detection unit 14 detects that the first earphone 10A has become a removed state, in other words, a non-mounted state. The communication controller 32 causes the communication unit 16 to transmit the result of the detection by the wearing detection unit 14 to the management device 20.

In the management device 20, the communication unit 16 receives the result of the detection by the wearing detection unit 14. The state detection unit 52 detects that the first earphone 10A has become the non-mounted state, in other words, the first earphone 10A has become the non-predetermined state based on the result of the detection by the wearing detection unit 14. The connection with the management device 20 is cut, for example, when the battery remaining amount of the first earphone 10A has become zero. In this case, the state detection unit 52 detects that the first earphone 10A has become the non-connected state, in other words, the first earphone 10A has become the non-predetermined state. The state detection unit 52 stores, in the storage 24, a time at which the first earphone 10A becomes the non-predetermined state.

The determination unit 53 determines whether the time at which the earphone 10A becomes the non-predetermined state is later than a work-finish scheduled time of the user. When it determined that the work-finish scheduled time is passed, the determination unit 53 regards the time stored in the storage 24 as the work-finish time and determines that the user has finished work.

After it is determined that the time at which the earphone 10A became the non-predetermined state is not later than the work-finish scheduled time of the user, the determination unit 53 determines that the user is at work when it is detected by the state detection unit 52 that the first earphone 10A returns to the predetermined state or the second earphone 10B becomes the predetermined state before a predetermined time elapses after the detection of the non-predetermined state of the first earphone 10A.

For example, when the second earphone 10B is mounted on the user as illustrated in a lower part of FIG. 10 before the predetermined time elapses after the detection of the non-predetermined state of the first earphone 10A, the mounted state is detected by the wearing detection unit 14. When the result of the detection by the wearing detection unit 14 is transmitted to the management device 20, it is detected by the state detection unit 52 that the second earphone 10B has become the mounted state, in other words, the second earphone 10B has become the predetermined state. In this case, the determination unit 53 determines that the user is at work.

When it is detected by the state detection unit 52 that the first earphone 10A has returned to the predetermined state or the second earphone 10B has become the predetermined state after the predetermined time elapses after the detection of the non-predetermined state of the first earphone 10A, the determination unit 53 determines that the user has been at non-work in the non-predetermined duration of the first earphone 10A. Similarly to the first embodiment, the result of detection by the state detection unit 52 may be presented to the user for confirmation, and the determination unit 53 may perform the determination based on information indicating that the result is confirmed by the user as a trigger.

The biological information management unit 55 stores the biological information received from the first earphone 10A and the second earphone 10B and the detection time of the biological information in association with each other in the storage 24. For example, the biological information management unit 55 detects whether the biological information includes anomaly or the like. When it is detected anomaly or the like, the biological information management unit 55 causes the communication unit 23 to transmit a notification of the detection to, for example, an external device.

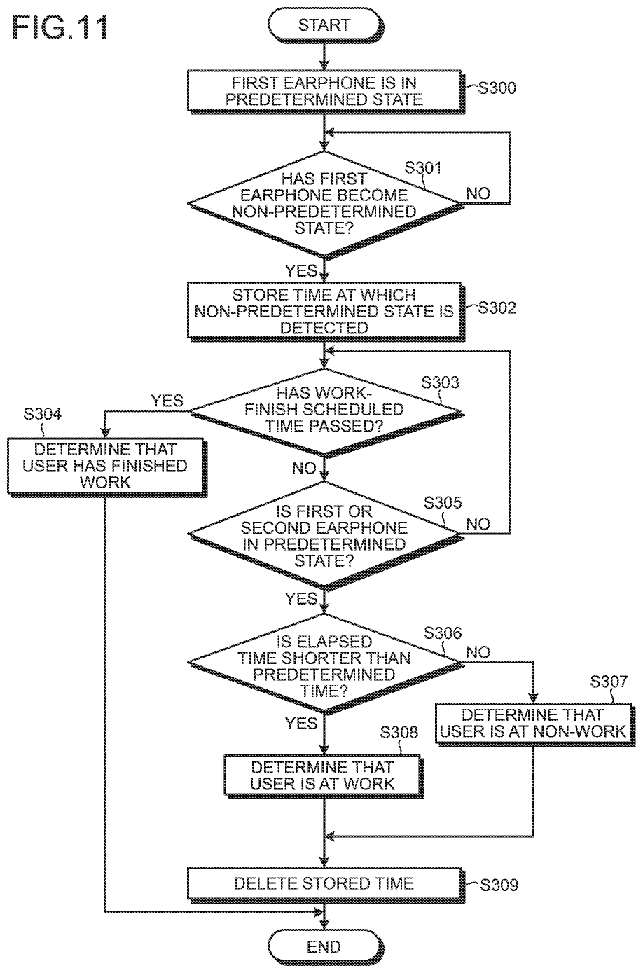

FIG. 11 is a flowchart illustrating an exemplary processes of operation of the attendance management system 200 according to the present embodiment. The first earphone 10A and the second earphone 10B are authenticated by the management device 20 in advance before the operation of the present flowchart.

When the first earphone 10A is powered on by the user, a connected state is achieved between the first earphone 10A and the management device 20 by the communication controller 32. When the first earphone 10A is mounted on the user, the first earphone 10A becomes the mounted state. In the management device 20, it is detected by the state detection unit 52 that the first earphone 10A is in the connected state and the mounted state, in other words, in the predetermined state, and it is determined by the determination unit 53 that the user is at work (step S300, so far).

Thereafter, the determination unit 53 determines whether it is detected that the first earphone 10A has become the non-predetermined state (step S301). When it is not detected the first earphone 10A has become the non-predetermined state (No at step S301), the processing at step S301 is repeated. When it is detected that the first earphone 10A has become the non-predetermined state (Yes at step S301), the determination unit 53 stores the time of the detection in the storage 24 (step S302).

The determination unit 53 determines whether the time at which the earphone 10 becomes the non-predetermined state is later than the work-finish scheduled time of the user (step S303). When it is determined that the work-finish scheduled time has passed (Yes at step S303), the determination unit 53 regards the time stored in the storage 24 as the work-finish time, determines that the user has finished work (step S304), and then ends the processes.

When it is determined that the work-finish scheduled time has not passed (No at step S303), the determination unit 53 determines whether it is detected that the first earphone 10A has returned to the predetermined state or the second earphone 10B has become the predetermined state (step S305). When it is not detected that the first earphone 10A has returned to the predetermined state and the second earphone 10B has become the predetermined state (No at step S305), the processing at step S303 and the later are repeated. When it is detected that the first earphone 10A has returned to the predetermined state or the second earphone 10B has become the predetermined state (Yes at step S305), the determination unit 53 determines whether a time from the time at which the earphone 10A became the non-predetermined state to the time at which the earphone 10A has become the predetermined state again or the second earphone 10B has become the predetermined state is shorter than a predetermined time (step S306). When it is determined that the non-predetermined duration is not shorter than the predetermined time (No at step S306), the determination unit 53 determines that the user has been at non-work in the non-predetermined duration (step S307).

When it is determined that the non-predetermined duration is shorter than the predetermined time (Yes at step S306), the determination unit 53 determines that the user has been at work in the non-predetermined duration (step S308). After steps S307 and S308, the controller 25 deletes, from the storage 24, the time at which the first earphone 10A became the non-predetermined state (step S309), and then completes the processes.

As described above, the attendance management system 200 according to the present embodiment includes the management device 20 configured to manage the attendance of the user, and the earphones 10A and 10B capable of performing the wireless communication with the management device 20. Each of the earphones 10A and 10B can detect whether the earphone 10 is mounted on the user and transmit the result of the detection to the management device 20. The management device 20 determines that the user is at work, when it is detected that the predetermined state in which the first earphone 10A as one of the earphones 10A and 10B is communicably connected to the management device 20 and is mounted on the user.

According to the present embodiment, the attendance status of the user can be determined based on the use state of any of the earphones 10A and 10B, and thus the attendance status of the user can be easily managed. Moreover, when the battery remaining amount of one of the earphones 10A and 10B has become zero, the same attendance management can be performed by using the other earphone.

In the attendance management system 200 according to the present embodiment, after having detected that the first earphone 10A in the predetermined state has become the non-predetermined state different from the predetermined state, the management device 20 determines that the user is at work in the non-predetermined duration of the first earphone 10A, when it is detected that the first earphone 10A has returned to the predetermined state or the second earphone 10B has become the predetermined state before the predetermined time elapses after the detection of the non-predetermined state of the first earphone 10A, and the management device 20 also determines that the user has been at non-work in the non-predetermined duration of the first earphone 10A, when it is detected that the first earphone 10A has returned to the predetermined state or the second earphone 10B has become the predetermined state after the predetermined time elapses after the detection of the non-predetermined state of the first earphone 10A. With this configuration, the non-predetermined state in a time shorter than the predetermined time is determined as a state at work, and thus the attendance status of the user can be realistically managed.

In the attendance management system 200 according to the present embodiment, the management device 20 determines that the user has finished work, when it is detected that the earphone 10A or 10B in the predetermined state has become the non-predetermined state after the work-finish scheduled time. With this configuration, it can be easily managed that the user has finished work.

In the attendance management system 200 according to the present embodiment, after it is detected that the earphone 10A or 10B has become the predetermined state or the non-predetermined state, the management device 20 determines the attendance of the user when it receives the information allowing the user to confirm that the earphone 10A or 10B has become the predetermined state or the non-predetermined state. With this configuration, it is possible to allow the user to reliably recognize the result of the determination by the management device 20.

In the attendance management system 200 according to the present embodiment, at least one of the earphones (10A and 10B) mounted on the user acquires the biological information of the user and transmits the acquired biological information to the management device 20, and the management device 20 manages the health of the user based on the biological information of the user. With this configuration, the management device 20 can manage the attendance of the user as well as the health thereof.

The technological range of the present disclosure is not limited to the above-described embodiments but may be modified as appropriate without departing the scope of the present disclosure.

According to the present disclosure, it is possible to easily perform an attendance status management.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An attendance management system comprising:
a management device configured to manage attendance of a user; and
one earphone capable of performing a wireless communication with the management device, wherein
the earphone is capable of detecting whether the earphone is mounted on the user and transmitting a result of the detection to the management device, and
the management device is further configured to determine that the user is at work when it is detected that a use state of the earphone is a predetermined state in which the earphone is communicably connected to the management device and mounted on the user.

2. The attendance management system according to claim 1, wherein, after it is detected that the earphone in the predetermined state has become a non-predetermined state as the use state which is different from the predetermined state, the management device is further configured to;
determine that the user is at work in a non-predetermined duration in which the earphone is in the non-predetermined state when it is detected that the earphone has returned to the predetermined state before a predetermined time elapses after the detection of the non-predetermined state; and
determine that the user has not been at work in the non-predetermined duration when it is detected that the earphone has returned to the predetermined state after the predetermined time elapses after the detection of the non-predetermined state.

3. The attendance management system according to claim 2, wherein the management device is further configured to determine that the user has finished work when it is detected that the earphone in the predetermined state has become the non-predetermined state after a work-finish scheduled time.

4. The attendance management system according to claim 2, wherein, after it is detected that the earphone has become the predetermined state or the non-predetermined state, the management device determines the attendance of the user when it receives information allowing the user to confirm that the earphone has become the predetermined state or the non-predetermined state.

5. The attendance management system according to claim 1, wherein
the earphone mounted on the user is further configured to acquire a biological information of the user and to transmit the acquired biological information to the management device, and
the management device is further configured to manage health of the user based on the biological information of the user.

6. An attendance management system comprising:
a management device configured to manage attendance of a user; and
multiple earphones capable of performing a wireless communication with the management device respectively, wherein
each of the earphones is capable of detecting whether the earphone is mounted on the user and transmitting a result of the detection to the management device, and
the management device is further configured to determine that the user is at work when it is detected that a use state of a first earphone as one of the multiple earphones is a predetermined state in which the earphone is communicably connected to the management device and mounted on the user.

7. The attendance management system according to claim 6, wherein, the management device is further configured to:
after it is detected that the first earphone in the predetermined state has become a non-predetermined state different from the predetermined state,
determine that the user is at work in a non-predetermined duration in which the first earphone is in the non-predetermined state when it is detected that the first earphone has returned to the predetermined state before a predetermined time elapses after the detection of the non-predetermined state of the first earphone or when it is detected that a second earphone different from the first earphone among the earphones has become the predetermined state before the predetermined time elapses after the detection of the non-predetermined state of the first earphone; and
determine that the user has not been at work in the non-predetermined duration when it is detected that the first earphone has returned to the predetermined state after the predetermined time elapses after the detection of the non-predetermined state of the first earphone or when it is detected that the second earphone has become the predetermined state after the predetermined time elapses after the detection of the non-predetermined state of the first earphone.

8. The attendance management system according to claim 7, wherein the management device is further configured to determine that the user has finished work when it is detected that the earphone in the predetermined state has become the non-predetermined state after a work-finish scheduled time.

9. The attendance management system according to claim 7, wherein, after it is detected that the earphone has become the predetermined state or the non-predetermined state, the management device is further configured to determines the attendance of the user when it receives information allowing the user to confirm that the earphone has become the predetermined state or the non-predetermined state.

10. The attendance management system according to claim 6, wherein
at least one of the earphones mounted on the user is further configured to acquire a biological information of the user and transmits the acquired biological information to the management device, and
the management device is further configured to manage health of the user based on the biological information of the user.
